(19) United States
(12) Patent Application Publication
(10) Pub. No.: US 2025/0209371 A1
(43) Pub. Date: Jun. 26, 2025

(54) DATASET FAIRNESS

(71) Applicant: Lemon Inc., Grand Cayman (KY)

(72) Inventors: Yang LIU, Los Angeles, CA (US); Jean-Francois TON, London (GB); Muhammad Faaiz TAUFIQ, London (GB)

(21) Appl. No.: 18/391,929

(22) Filed: Dec. 21, 2023

(51) Int. Cl. G06N 20/00

(52) U.S. Cl. CPC G06N 20/00

(57) ABSTRACT

The present application relates to a method of obtaining a machine learning model and dataset for training the machine learning model to estimate a fairness-accuracy curve of machine learning model and data and determine confidence intervals for the fairness-accuracy model, and a system and software for carrying out the method.

The present application relates to a method of obtaining a machine learning model and dataset for training the machine learning model to estimate a fairness-accuracy curve of the trained machine learning model and determine confidence intervals for the fairness-accuracy model, and a system and software for carrying out the method.

### BACKGROUND

In machine learning fairness, training models which minimize disparity across different sensitive groups in dataset often leads to diminished accuracy of the trained machine learning model. The relationship between fairness and accuracy of a machine learning model and a dataset is commonly known as the fairness-accuracy trade-off. The severity of this trade-off fundamentally depends on characteristics of the dataset such as dataset imbalances or biases, and therefore using a universal fairness requirement across different datasets can unreliable fairness-accuracy determination.

This raises significant challenges for deploying these models in practical settings. One application of determining and adjusting fairness-accuracy in machine learning is training machine learning models to minimize the disparity across various sensitive groups such as race or gender. For example, consider two crime datasets: Dataset A has records from a community where crime rates are uniformly distributed across all racial groups, whereas dataset B comes from a community where historical factors have resulted in a disproportionate crime rate among a specific racial group. Intuitively, training models which are racially agnostic is more challenging for the latter, due to the unequal distribution of crime rates across racial groups in the former. Thus, applying the same fairness-accuracy trade-off to both datasets may not be suitable to account for the different characteristics and underlying biases of both datasets.

This example underscores one of the main challenges in fairness for machine learning models. More specifically, setting a uniform requirement for fairness while also adhering to essential accuracy benchmarks is impractical across diverse datasets. Current methods seek to determine an accuracy of a model for a given fairness value. However, there is a need to determine a range of achievable fairness violations for a required model accuracy in order to maintain essential model accuracy benchmarks. Specifically, there is a desire to determine a range of permissible fairness violation for a given dataset, model class, and desired accuracy. There have been attempts to determine accuracy of a model for a given fairness value; however, current methods are not computationally efficient and only determine an accuracy of the model for a single fairness value.

Accordingly, there is a need for a computationally efficient method to approximate the fairness-accuracy trade-off relationship tailored to individual models and datasets for a large range of fairness and accuracy values.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

According to a first aspect, there is a computer implemented method, the method comprising: obtaining a machine learning model; obtaining a dataset for training the machine learning model to produce a trained machine learning model; estimating a fairness-accuracy curve of the trained machine learning model by training the machine learning model on the dataset, wherein the fairness-accuracy curve comprises a plurality of fairness values corresponding to a plurality of accuracy values; and determining confidence intervals for the plurality of fairness values of the fairness-accuracy curve, wherein a confidence interval is a range of expected fairness values for a fairness value corresponding to an accuracy value.

According to an embodiment, the method discloses determining the confidence intervals comprises using calibration dataset, wherein the calibration dataset is disjoint from the dataset.

According to an embodiment, the method discloses the probability of the fairness value being within the range of the expected fairness values is defined as:

$$P ( {τ}_{fair}^{*} ( ψ ) ∈ {Γ}_{fair}^{α} ) \geq 1 - α ,$$

wherein: τ_{fair}*(ψ) is the fairness-accuracy curve and τ_{fair}*: [0,1]→[0,1]; Γ_{fair}^{α} are the confidence intervals, wherein Γ_{fair}^{α}⊂[0,1]; α is the significance level, wherein α∈(0,1); and ψ are random variables.

According to an embodiment, the method discloses a ground-truth fairness-accuracy curve lies within the confidence intervals of the fairness-accuracy curve.

According to an embodiment, the method discloses a ground-truth fairness-accuracy curve lies within the confidence intervals of the fairness-accuracy curve.

According to an embodiment, the method discloses estimating the fairness-accuracy curve comprises utilizing the You-Only-Train-Once framework.

According to an embodiment, the method discloses the method comprises dynamically estimating the fairness-accuracy curve during inference of the machine learning model.

According to an embodiment, the method discloses the plurality of fairness values each represent a compromised fairness value depending on its corresponding plurality of accuracy values.

According to an embodiment, the method discloses the fairness-accuracy curve to be estimated is:

$${τ}_{fair}^{*} ( ψ ) := {min}_{h ∈ H} {Φ}_{fair} ( h ) subject to acc ( h ) \geq ψ ,$$

wherein: τ_{fair}*( ) is the fairness-accuracy curve and τ_{fair}*: [0,1]→[0,1]; ψ is an accuracy value from the plurality of accuracy values and ψ∈[0, 1]; h is the model from a set of models H; ϕ_{fair}( ) is a function for determining fairness; and Acc( ) is a function for determining accuracy.

According to an embodiment, the method discloses training the model on the dataset comprises training the model on a regularized loss defined as:

$${L}_{λ} ( θ ) = E [ {L}_{CE} ( {h}_{θ} ( X ) , Y ) ] + λ {L}_{fair} ( {h}_{θ} ) ,$$

wherein: L_{λ}(θ) is the regularized loss function; θ are weights of the model; E[ ] is the expected value function; L_{CE} is the cross-entropy loss function; h^{θ} is the model; X is the feature vector; Y is the label feature; λ is the regularization parameter; L^{fair} is a fairness violation loss function of the fairness violation ϕ_{fair}(h).

According to an embodiment, the method discloses training the model on the dataset comprises training the model on a regularized loss defined as:

$$\begin{matrix}arg min \\ {h}_{θ} : X \times ∧ \to R\end{matrix} {E}_{λ ∼ {P}_{λ}} [ E [ {L}_{CE} ( {h}_{θ} ( X , λ ) , Y ) ] + λ {L}_{fair} ( {h}_{θ} ( \cdot , λ ) ) ] ,$$

wherein: h_{θ} is the model; X is the feature vector; Λ is the space of regularization parameters λ; λ is the regularization parameter; P_{λ} is a distribution of regularization parameters; L_{CE} is the cross-entropy loss function; Y is the label feature; and L_{fair} is a fairness violation loss function of the fairness violation ϕ_{fair}(h).

According to an embodiment, the method discloses the fairness-accuracy curve is estimated as

$${τ}_{fair}^{*} ( ψ ) \approx \begin{matrix}min \\ i ∈ \{ 1 , … , k \}\end{matrix} \{ ( {h}_{{θ}_{{λ}_{i}}^{*}} ) \vert ( {h}_{{θ}_{{λ}_{i}}^{*}} ) \geq ψ \} ,$$

wherein: τ_{fair}*( ) is the fairness-accuracy curve and τ_{fair}*: [0, 1]→[0,1]; ψ is an accuracy value from the plurality of accuracy values and ψ∈[0, 1]; i is an index for a sample of the dataset; k is a total number of samples in the data set; [symbol] ( ) is a function for determining fairness; [symbol] ( ) is a function for determining accuracy; and

$${h}_{{θ}_{{λ}_{i}}^{*}}$$

is the model

According to an embodiment, the method discloses the fairness is at least one of: demographic parity, equalized opportunity, and equalized odds.

According to a second aspect, there is a data processing system comprising means for carrying out any of the above methods.

According to a third aspect, there is a computer program comprising instructions which, when the program is executed by a computer, cause the computer to carry out any of the above methods.

A computer-readable medium comprising instructions which, when executed by a computer, cause the computer to carry out any of the above methods.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a flow chart of a computer implemented method for estimating a fairness-accuracy curve of a trained machine learning model and determining confidence intervals for the fairness accuracy curve;

FIG. 2 shows a graph comprising the fairness accuracy curve and corresponding confidence intervals of the trained machine learning model; and

FIG. 3 shows a computing system 2000, on which any of the above-described methods may be performed.

Common reference numerals are used throughout the figures to indicate similar features.

### DETAILED DESCRIPTION

Embodiments of the present invention are described below by way of example only. These examples represent the best mode of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

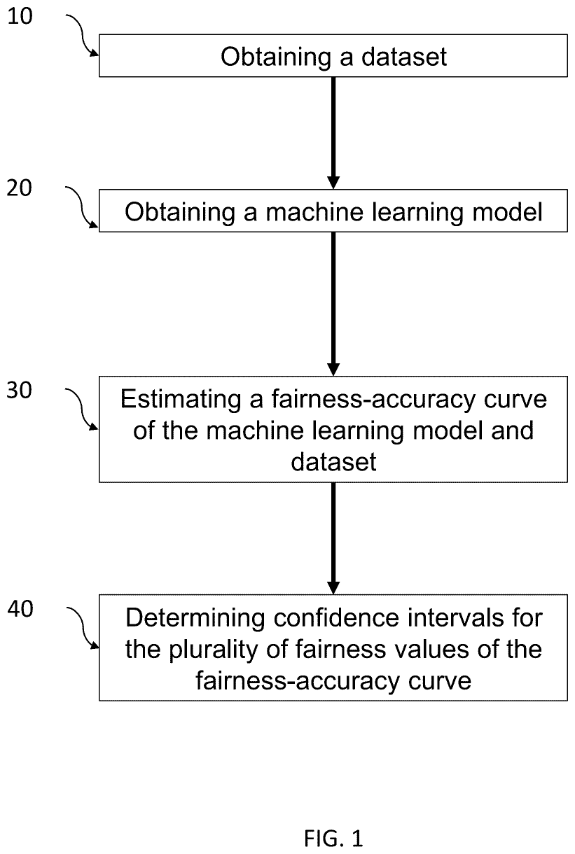

FIG. 1 shows a flow chart of a computer implemented method for estimating a fairness-accuracy curve of a trained machine learning model and determining confidence intervals for the fairness accuracy curve.

The method provides computationally efficient method to estimate the fairness-accuracy curve and provide a range of expected fairness values for each accuracy value.

In step 10, the method comprises obtaining a dataset for training the machine learning model. The dataset can comprise a plurality of training samples. All the methods and systems disclosed herein can be used on any type of dataset. Example datasets include, but are not limited to, at least one of the following: a tabular dataset, a computer vision dataset, time series dataset, graph datasets, audio dataset, geospatial dataset, and a natural language dataset.

Each training sample may comprise the following triples, (X, A, Y). X∈X denotes a vector of features, wherein X is a vector of features from a set of vector of features X. A∈A represents a sensitive attribute, wherein A is a sensitive attribute from a set of vector of features A. Y∈Y:={0, 1} represents a label, wherein Y is a label from a set of labels Y. In the illustrated embodiment, the set of possible labels can be defined as Y:={0, 1}; however, the skilled person would understand that other set of labels can be defined.

The vector of features can include, but is not limited to, at least one of the following: demographic features; gender; race; ethnicity; salary; height; any individual features; and any other features depending on the technical problem to be solved.

Sensitive attributes can include, but is not limited to, at least one of the following: gender; race; ethnicity; salary; wealth; and any other features depending on the technical problem to be solved.

Labels can include, but is not limited to, at least one of the following: a binary classification; category classification; and any other labels depending on the technical problem to be solved.

In a specific example, the vector of features X comprise an income level of a person, a loan amount of the person, previous payment records of the person; the sensitive attribute A comprises a racial identity of the person; and the label Y comprises a loan default prediction.

In step 20, the method comprises obtaining a machine learning model. The machine learning model is expressed as “h” herein. The machine learning model h is taken from a model class H. The model class can be, for example, neural networks. The class of models can be a parameterized family of classifiers H={h_{θ}: X→R|θ∈Θ}, such as neural networks, with predictions Ŷ=1 (h_{θ}(X)>0). R is a real number. θ are the weights of the model h. Θ is the parameter space of the model h. For each parameter space Θ there may be a Rd space, wherein a weight θ is a vector in the R^{d} space.

The machine learning model can be any model. Example machine learning models include but are not limited to, neural networks, and any other gradient based models.

In step 30, the method comprises estimating the fairness-accuracy curve of the trained machine learning model.

An accuracy of the machine learning model can be defined as a percentage of correct predictions. The accuracy of a model h is expressed as acc(h). The accuracy threshold, or a desired minimum accuracy of the model h, is expressed as ψ, wherein ψ∈[0, 1].

The fairness value can be any metric of fairness of a model trained on the dataset, which is hereinafter referred to as a trained model. In an embodiment, the fairness value can be a fairness violation value, wherein the fairness violation value is an amount of fairness compromised depending on the accuracy value. Accordingly, the plurality of fairness values can each represent a compromised fairness value depending on its corresponding plurality of accuracy values. Examples include, but are not limited to, at least one of: demographic parity, equalized opportunity, and equalized odds.

Demographic parity is when the selection rates for all sensitive attributes A are equal. An ideal demographic parity is defined as P(h(X)=1|A=a)=P(h(X)=1) for any a∈A, wherein a is an example sensitive attribute. The fairness violation value of demographic parity is defined as

$${Φ}_{DP} ( h ) := \vert P ( h ( X ) = 1 \vert A = 1 ) - P ( h ( X ) = 1 \vert A = 0 ) \vert .$$

Equalized opportunity is when the true positive rates for all sensitive groups are equal. An ideal equalized opportunity is defined as P(h(X)=1|A=a, Y=1)=P(h(X)=1|Y=1) for any a∈A. The fairness violation value of equalized opportunity is defined as

$${Φ}_{EOP} ( h ) := \vert P ( h ( X ) = 1 \vert A = 1 , Y = 1 ) - P ( h ( X ) = 1 \vert A = 0 , Y = 1 ) \vert .$$

The fairness violation value can be expressed as ϕ_{fair}(h)∈[0, 1] in the setting when Y=A={0, 1}. For example, for an accuracy value of 0.8, the fairness violation value can be 0.65 and for an accuracy value of 0.99, the fairness violation value can be 0.95. The estimation of the fairness-accuracy curve seeks to minimize the fairness violation value in order to optimize the fairness of the model for a given accuracy of the model. Accordingly, the fairness-accuracy curve, for a trained machine learning model, for accuracies above an accuracy threshold, can be expressed as:

$${τ}_{fair}^{*} ( ψ ) := {min}_{h ∈ H} {Φ}_{fair} ( h ) subject to acc ( h ) \geq ψ , \qquad equation 1$$

wherein:
τ_{fair}*( ) is the fairness-accuracy curve and τ_{fair}*: [0, 1]→[0,1];
ψ is an accuracy value from the plurality of accuracy values and ψ∈[0, 1];
h is the model from a set of models H;
ϕ_{fair}( ) is a function for determining fairness; and
Acc( ) is a function for determining accuracy.

Estimating the fairness-accuracy curve comprises mapping the accuracy values and fairness values of the fairness-accuracy curve as τ_{fair}*: [0, 1]→[0,1].

As mentioned above, there is a desire to determine a range of permissible fairness violation values for a given dataset, model, with respect to the accuracy of the model. One solution is to determine a ground-truth fairness-accuracy curve of the model when trained on the dataset. The ground-truth fairness-accuracy curve shows a minimum fairness violation with respect to an accuracy of the trained machine learning model. The ground-truth fairness-accuracy curve could serve as a look-up table to determine fairness violations given a desired accuracy. However, the ground-truth fairness-accuracy curve is often unavailable and hence, various optimization techniques are proposed to estimate the ground-truth fairness-accuracy curve.

Obtaining the exact ground-truth fairness-accuracy curve τ_{fair}*(ψ) defined in equation 1 is inherently challenging for several reasons. Firstly, dataset is finite, which restricts our ability to compute the exact values of accuracy acc(h) and fairness violation ϕ_{fair}(h). Secondly, the constrained optimization problem in equation 1 required to obtain the value of τ_{fair}*(ψ) is non-trivial to solve exactly and may require training several separate machine learning models across different accuracy constraints. See, for example, empirical fairness-accuracy curve 420, wherein each dot on the empirical fairness-accuracy curve 420 corresponds to a single trained machine learning model.

In an embodiment, the fairness-accuracy curve of the trained machine learning model can be estimated by training the machine learning model using a regularized loss defined as:

$${L}_{λ} ( θ ) = E [ {L}_{CE} ( {h}_{θ} ( X ) , Y ) ] + λ {L}_{fair} ( {h}_{θ} ) , \qquad equation 2$$

wherein:
L_{λ}(θ) is the regularized loss function;
θ are weights of the model;
E[ ] is the expected value function;
L_{CE} is the cross-entropy loss function;
h_{θ} is the model;
X is the feature vector;
Y is the label feature;
λ is the regularization parameter; and
L_{fair} is a fairness violation loss function of the fairness violation ϕ_{fair}(h).

The parameter λ∈R≥0 in L_{λ} modulates the accuracy-fairness trade-off with lower values of A favouring higher accuracy over reduced fairness violation and vice-versa. Therefore, given an accuracy threshold ψ, there exists a value of λ≥0 such that the loss L_{λ}(θ) in Equation 2 provides a smooth surrogate loss for the constrained optimisation problem in Equation 1. The surrogate loss can be optimised using gradient based optimisation methods. Obtaining the estimated fairness-accuracy curve comprises optimizing over a grid of π's, wherein θ_{λ}_{ᵢ}*∈Θ be the minimiser of loss L_{λ}.

In an embodiment, the fairness-accuracy curve of the trained machine learning model can be estimated as:

$${τ}_{fair}^{*} ( ψ ) \approx \begin{matrix}min \\ i ∈ \{ 1 , … , k \}\end{matrix} \{ ( {h}_{{θ}_{{λ}_{i}}^{*}} ) \vert ( {h}_{{θ}_{{λ}_{i}}^{*}} ) \geq ψ \} ,$$

wherein:
τ_{fair}*( ) is the fairness-accuracy curve and τ_{fair}*: [0, 1]→[0,1];
ψ is an accuracy value from the plurality of accuracy values and ψ∈[0, 1];
i is an index for a sample of the dataset;
k is a total number of samples in the data set;
[symbol] ( ) is a function for determining fairness;
[symbol] ( ) is a function for determining accuracy;

$${h}_{{θ}_{{λ}_{i}}^{*}}$$

is the model

$${θ}_{λ}^{*} = arg {min}_{θ ∈ ⊖} {L}_{λ} ( θ ) = E [ {L}_{CE} ( {h}_{θ} ( X ) , Y ) ] + λ {L}_{fair} ( {h}_{θ} ) .$$

[symbol] (h_{θ}_{_{λ}}*) and [symbol] (h_{θ}_{_{λ}}*) denote the empirical fairness violation and accuracy of the classifier Ý=1(h_{θ}(X)>0) on held-out data. However, training multiple models can be computationally expensive, especially when the model class H are large-scale models (e.g. neural networks). Moreover, the accuracy and fairness violations acc(h_{θ}_{_{λ}}*), ϕ_{fair}(h_{θ}_{_{λ}}*) may not vary continuously with changing values of λ, and a small increase in the value of λ could lead to a large shift in the relationship between accuracy and fairness violations. Consequently, it is challenging to find models which have an accuracy close to a given value ψ as the λ parameter offers little control over the model accuracy acc(h_{θ}_{_{λ}}*).

Accordingly, in an embodiment, the method comprises estimating the fairness-accuracy curve by utilizing the You-Only-Train-Once (YOTO) framework. The YOTO framework allows a single model to be trained to determine a fairness-accuracy curve of the model comprising a plurality of fairness values corresponding to a plurality of accuracy values.

Advantageously, the YOTO framework avoids the computational overhead associated with training multiple models when estimating the fairness-accuracy curve. The model to be trained when using the YOTO framework can be defined as h_{θ}: X×Λ→R, which takes λ∈Λ⊂R as an additional input, and is trained such that at inference time h_{θ} (•, λ′) recovers the classifier obtained by minimising L_{λ′}. Λ is the space of regularization parameters λ.

As mentioned above, obtaining the estimated fairness-accuracy curve comprises optimizing over a grid of λ's, wherein θ_{λ}_{ᵢ}*∈Θ is the minimiser of loss L_{λ}. In the YOTO frame work, instead of fixing λ, the YOTO framework solves an optimisation problem where the parameter λ is sampled from a distribution P_{λ}. As a result, during training, the model observes many different values of λ and learns to optimise the loss L_{λ} for all values of λ simultaneously.

In an embodiment, the fairness-accuracy curve can be estimated by training the machine learning model using an updated regularized loss defined as:

$$\begin{matrix}arg min \\ {h}_{θ} : X \times ∧ \to R\end{matrix} {E}_{λ ∼ {P}_{λ}} [ E [ {L}_{CE} ( {h}_{θ} ( X , λ ) , Y ) ] + λ {L}_{fair} ( {h}_{θ} ( \cdot , λ ) ) ]$$

wherein:
h_{θ} is the model;
X is the feature vector;
Λ is the space of regularization parameters A;
λ is the regularization parameter;
P_{λ} is the distribution of regularization parameters;
L_{CE} is the cross-entropy loss function;
Y is the label feature; and
L_{fair} is a fairness violation loss function of the fairness violation ϕ_{fair}(h).

In an embodiment, the fairness-accuracy curve can be estimated as:

$${τ}_{fair}^{*} ( ψ ) \approx \begin{matrix}min \\ i ∈ \{ 1 , … , k \}\end{matrix} \{ ( {h}_{{θ}_{{λ}_{i}}^{*}} ) \vert ( {h}_{{θ}_{{λ}_{i}}^{*}} ) \geq ψ \}$$

wherein:
τ_{fair}*( ) is the fairness-accuracy curve and τ_{fair}*: [0, 1]→[0,1];
ψ is an accuracy value from the plurality of accuracy values and ψ∈[0,1];
i is an index for a sample of the dataset;
k is a total number of samples in the data set;
[symbol] ( ) is a function for determining fairness;
[symbol] ( ) is a function for determining accuracy;

$${h}_{{θ}_{{λ}_{i}}^{*}}$$

is the model; and

$${θ}_{λ}^{*} = \begin{matrix}arg min \\ {h}_{θ} : X \times ∧ \to R\end{matrix} {E}_{λ ∼ {P}_{λ}} [ E [ {L}_{CE} ( {h}_{θ} ( X , λ ) , Y ) ] + λ {L}_{fair} ( {h}_{θ} ( \cdot , λ ) ) ] .$$

Advantageously, the regularized loss of the YOTO framework mitigates the computation burden of having to train multiple models when approximating the trade-off curve.

In an embodiment, the method comprises dynamically estimating the fairness-accuracy curve during inference of the machine learning model. At inference time, the model can be conditioned on a chosen parameter value λ′ and recovers the model trained to optimise L_{λ′}.

Advantageously, the fairness-accuracy curve τ_{fair}*(ψ) helps to characterize dataset fairness of the dataset.

In step 40, the method comprises determining confidence intervals for the plurality of fairness values of the fairness-accuracy curve. The confidence interval is a range of expected fairness values for a fairness value corresponding to an accuracy value.

In an embodiment, the probability of the fairness value being within the range of the expected fairness values is defined as:

$$P ( {τ}_{fair}^{*} ( ψ ) ∈ {Γ}_{fair}^{α} ) \geq 1 - α ,$$

wherein:
τ_{fair}*(ψ) is the fairness-accuracy curve and τ_{fair}*: [0,1]→[0,1];
Γ_{fair}^{α} are the confidence intervals, wherein δ_{fair}^{α}⊂[0,1];
α is the significance level, wherein α∈(0,1); and
Ψ are random variables, wherein Ψ are real numbers in [0, 1].

In an embodiment, the confidence intervals Γ_{fair}^{α} are determined using a calibration dataset D_{cal}, wherein the calibration dataset D_{cal} is disjoint from the dataset. The random variables Ψ are obtained from the calibration dataset D_{cal}, wherein D_{cal}:={(Xᵢ, Aᵢ, Yᵢ)}ᵢ. In an embodiment, the confidence intervals comprise an upper bound and a lower bound.

In an embodiment, the method comprises determining the confidence intervals using D_{cal} on accuracy acc(h) and fairness violation ϕ_{fair}(h) for a given model h, denoted as C_{acc}^{α}(h) and C_{fair}^{α}(h) respectively before applying the confidence intervals on τ_{fair}*(ψ). It is noted that P(acc(h)∈C_{acc}^{α}(h))≥1−α and P(ϕ_{fair}(h)∈C_{fair}^{α}(h))≥1−α. One possible way to construct these confidence intervals involves using assumption-light concentration inequalities such as Hoeffding's inequality. However, it is noted that the skilled person would understand that the confidence intervals may be determined using other assumption-light concentration inequalities, or other appropriate methods.

Advantageously, the confidence intervals provide a range of expected fairness values for a particular fairness values for a given dataset, model class, and desired accuracy.

Advantageously, the confidence intervals provides an acceptable range of fairness violations for any given accuracy value.

Advantageously, the confidence intervals provides the ability to adjust the fairness of the machine learning model whilst maintaining the accuracy of the machine learning model. The confidence intervals allow machine learning practitioners to make accuracy-constrained fairness decisions.

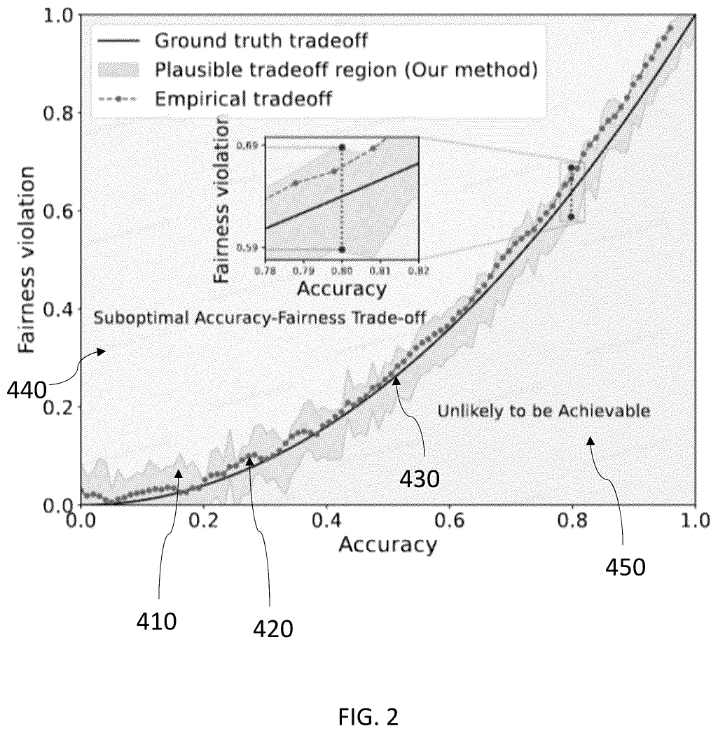

FIG. 2 shows a graph comprising the fairness accuracy curve and corresponding confidence intervals of the trained machine learning model.

The graph shows that the ground-truth fairness-accuracy curve 430 is within the confidence intervals of the estimated fairness-accuracy curve 410. The region bounded by the confidence intervals represents models h with an accuracy above the threshold accuracy and within a range of expected fairness values for a given accuracy value.

In an embodiment, the confidence intervals represent a range of admissible fairness violations for a given accuracy value. In an embodiment, an area above the confidence intervals 440 corresponds to a sub-optimal accuracy-fairness trade-off region. If a classifier h₀ with acc(h₀)≥ψ, the fairness violation value ϕ_{fair}(h₀) lies above the confidence intervals Γ_{fair}^{α}, then h₀ is likely to be suboptimal in terms of the fairness violation, i.e., ϕ_{fair}(h₀) can be reduced while keeping the accuracy fixed.

In an embodiment, an area below the confidence intervals 450 corresponds to accuracy-fairness trade-off region that is unlikely to be achievable. The fairness violation below the confidence interval Γ_{fair}^{α} is unlikely to be achieved by models with acc(h)≥ψ.

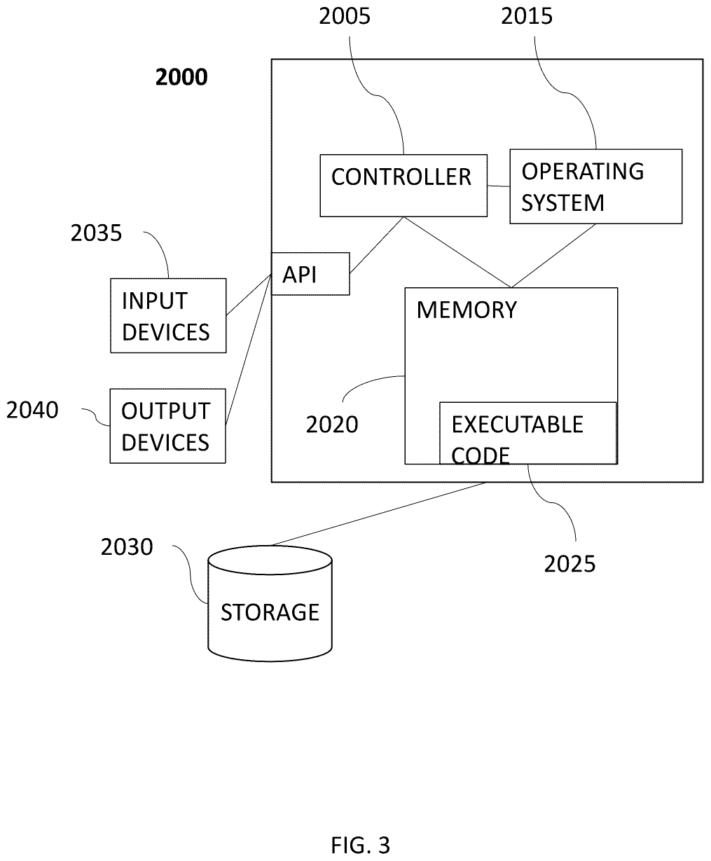

FIG. 3 shows a computing system 2000, on which any of the above-described methods may be performed. In particular, the Computing system 2000 may comprise a single computing device or components such as a laptop, tablet, desktop or other computing device. Alternatively functions of system 2000 may be distributed across multiple computing devices.

The Computing system 2000 may include one or more controllers such as controller 2005 that may be, for example, a central processing unit processor (CPU), a graphics processing unit (GPU) a chip or any suitable processor or computing or computational device such as an FPGA mentioned, an operating system 2015, a memory 2020 storing executable code 2025, storage 2030 which may be external to the system or embedded in memory 2020, one or more input devices 2035 and one or more output devices 2040.

One or more processors in one or more controllers such as controller 2005 may be configured to carry out any of the methods described here. For example, one or more processors within controller 2005 may be connected to memory 2020 storing software or instructions that, when executed by the one or more processors, cause the one or more processors to carry out a method according to some embodiments of the present invention. Controller 2005 or a central processing unit within controller 2005 may be configured, for example, using instructions stored in memory 2020, to perform the method as described above.

Input devices 2035 may be or may include a mouse, a keyboard, a touch screen or pad or any suitable input device. It will be recognized that any suitable number of input devices may be operatively connected to computing system 2000 as shown by block 2035. Output devices 2040 may include one or more displays, speakers and/or any other suitable output devices. It will be recognized that any suitable number of output devices may be operatively connected to computing system 2000 as shown by block 2040. The input and output devices may for example be used to enable a user to select information, e.g., images and graphs as shown here, to be displayed

In the embodiments described above, all or parts of the method may be performed by a server. The server may comprise a single server or network of servers. In some examples, the functionality of the server may be provided by a network of servers distributed across a geographical area, such as a worldwide distributed network of servers, and a user/operator of the method may be connected to an appropriate one of the network servers based upon, for example, a user location.

The embodiments described above are fully automatic. In some examples a user or operator of the system may manually instruct some steps of the method to be carried out.

In the described embodiments of the invention parts of the system may be implemented as a form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Although illustrated as a single system, it is to be understood that a computing device may be a distributed system. Thus, for instance, several devices may be in communication by way of a network connection and may collectively perform tasks described as being performed by the computing device. Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A computer implemented method, the method comprising:
obtaining a machine learning model;
obtaining a dataset for training the machine learning model to produce a trained machine learning model;
estimating a fairness-accuracy curve of the trained machine learning model by training the machine learning model on the dataset, wherein the fairness-accuracy curve comprises a plurality of fairness values corresponding to a plurality of accuracy values; and
determining confidence intervals for the plurality of fairness values of the fairness-accuracy curve, wherein a confidence interval is a range of expected fairness values for a fairness value corresponding to an accuracy value.

2. A method according to claim 1, wherein determining the confidence intervals comprises using calibration dataset, wherein the calibration dataset is disjoint from the dataset.

3. A method according to claim 1, wherein the probability of the fairness value being within the range of the expected fairness values is defined as:
$$P ( {τ}_{fair}^{*} ( ψ ) ∈ {Γ}_{fair}^{α} ) \geq 1 - α ,$$
wherein:
τ_{fair}(ψ) is the fairness-accuracy curve and τ_{fair}*: [0,1]→[0,1];
Γ_{fair}^{α} are the confidence intervals, wherein Γ_{fair}^{α}⊂[0,1];
α is the significance level, wherein α∈(0,1); and
ψ are random variables.

4. A method according to claim 1, wherein a ground-truth fairness-accuracy curve lies within the confidence intervals of the fairness-accuracy curve.

5. A method according to claim 1, wherein estimating the fairness-accuracy curve comprises utilizing the You-Only-Train-Once framework.

6. A method according to claim 1, wherein the method comprises dynamically estimating the fairness-accuracy curve during inference of the machine learning model.

7. A method according to claim 1, wherein the plurality of fairness values each represent a compromised fairness value depending on its corresponding plurality of accuracy values.

8. A method according to claim 1, wherein the fairness-accuracy curve to be estimated is:
$${τ}_{fair}^{*} ( ψ ) := {min}_{h ∈ H} {Φ}_{fair} ( h ) subject to acc ( h ) \geq ψ ,$$
wherein:
τ_{fair}*( ) is the fairness-accuracy curve and τ_{fair}*: [0, 1]→[0,1];
ψ is an accuracy value from the plurality of accuracy values and ψ∈[0,1];
h is the model from a set of models H;
ϕ_{fair}( ) is a function for determining fairness; and
Acc( ) is a function for determining accuracy.

9. A method according to claim 1, wherein training the model on the dataset comprises training the model on a regularized loss defined as:
$${L}_{λ} ( θ ) = E [ {L}_{CE} ( {h}_{θ} ( X ) , Y ) ] + λ {L}_{fair} ( {h}_{θ} ) ,$$
wherein:
L_{λ}(θ) is the regularized loss function;
θ are weights of the model;
E[ ] is the expected value function;
L_{CE} is the cross-entropy loss function;
h_{θ} is the model;
X is the feature vector;
Y is the label feature;
λ is the regularization parameter;
L_{fair} is a fairness violation loss function of the fairness violation ϕ_{fair}(h).

10. A method according to claim 1, wherein training the model on the dataset comprises training the model on a regularized loss defined as:
$$\begin{matrix}arg min \\ {h}_{θ} : X \times ∧ \to R\end{matrix} {E}_{λ ∼ {P}_{λ}} [ E [ {L}_{CE} ( {h}_{θ} ( X , λ ) , Y ) ] + λ {L}_{fair} ( {h}_{θ} ( \cdot , λ ) ) ] ,$$
wherein:
h_{θ} is the model;
X is the feature vector;
Λ is the space of regularization parameters λ;
λ is the regularization parameter;
P_{λ} is a distribution of regularization parameters;
L_{CE} is the cross-entropy loss function;
Y is the label feature; and
L_{fair} is a fairness violation loss function of the fairness violation ϕ_{fair}(h).

11. A method according to claim 1, wherein the fairness-accuracy curve is estimated as
$${τ}_{fair}^{*} ( ψ ) \approx \begin{matrix}min \\ i ∈ \{ 1 , … , k \}\end{matrix} \{ ( {h}_{{θ}_{{λ}_{i}}^{*}} ) \vert ( {h}_{{θ}_{{λ}_{i}}^{*}} ) \geq ψ \} ,$$
wherein:
τ_{fair}*( ) is the fairness-accuracy curve and τ_{fair}*: [0, 1]→[0,1];
ψ is an accuracy value from the plurality of accuracy values and ψ∈[0, 1];
i is an index for a sample of the dataset;
k is a total number of samples in the data set; [symbol]
( ) is a function for determining fairness; [symbol]
( ) is a function for determining accuracy; and
$${h}_{{θ}_{{λ}_{i}}^{*}}$$
is the model.

12. A method according to claim 1, wherein the fairness is at least one of: demographic parity, equalized opportunity, and equalized odds.

13. A data processing system comprising means for carrying out the method of claim 1.

14. A computer program comprising instructions which, when the program is executed by a computer, cause the computer to carry out the method of claim 1.

15. A computer-readable medium comprising instructions which, when executed by a computer, cause the computer to carry out the method of claim 1.
